(19) United States
(12) Patent Application Publication
(10) Pub. No.: US 2004/0190661 A1
(43) Pub. Date: Sep. 30, 2004

(54) Method and system for equalizing communication signals

(75) Inventor: Michael Vrazel, Atlanta, GA (US)

Correspondence Address: KING & SPALDING LLP, 191 PEACHTREE STREET, N.E., ATLANTA, GA, 30303-1763, US

(73) Assignee: Quellan, Inc., Atlanta, GA

(21) Appl. No.: 10/809,756

(22) Filed: Mar. 25, 2004

Related U.S. Application Data
(60) Provisional application No. 60/457,655, filed on Mar. 26, 2003.

(51) Int. Cl. H04B 1/10

(52) U.S. Cl. 375/350

(57) ABSTRACT

A receiver that can include an adaptive equalizer and a comparator processes communication signals that have been distorted by a propagation medium. The adaptive equalizer can correct for distortion of the received signals. The comparator can accept the equalized signal from the equalizer and quantize this signal. A control loop coupled to the equalized signal and the quantized signal can adjust the equalizer. The control loop can adjust the equalizer so that the high frequency energy in the equalized signal approximates the high-frequency energy in the quantized signal, taking into account variation between the low-frequency energies of these two signals.

### CROSS REFERENCE TO RELATED APPLICATIONS

This application claims the benefit of priority to U.S. Provisional Pat. application Ser. No. 60/457,655, entitled “Method and Mechanism for Improved Equalization Control Loop,” and filed Mar. 26, 2003. The subject matter of U.S. Provisional Pat. application Ser. No. 60/457,655 is hereby incorporated by reference.

### FIELD OF THE INVENTION

The present invention relates to the field of communications, and more specifically to signal processing circuitry associated with a receiver that provides adaptive equalization of a communications signal.

### BACKGROUND

Typical transmission media for digital communication systems are both lossy and dispersive. These imperfections frequently result in impairments such as attenuation and inter-symbol interference (ISI) in signals that propagate through such media. These impairments increase in severity in correlation to increasing signal frequency and increasing channel length. In a typical digital communication system, an input signal, which is often a series of pulses sequences, is transmitted by a transmitter across a transmission medium and is corrupted by noise. The received signal is input to a receiver, which processes the signal to generate an output signal. The receiver may include an equalizer, which may be fixed or adaptive. The equalizer compensates for the signal distortions induced by the transmission medium, restoring the fidelity of the received signal to a degree comparable to that of the transmitted signal. In many applications, a receiver needs to accommodate a variety of data transmission rates, signal spectra, and channel lengths, all of which can affect the amount of distortion that the received signal exhibits. Hence, an adaptive equalizer typically offers benefits over a fixed equalizer since the amount of compensation required to adequately restore signal fidelity may not be known a priori.

A variety of conventional adaptive equalizer architectures are known in the art. A specific architecture is sometimes selected for an application based on the channel characteristics of that application and the correlation between those channel characteristics and the various parameters associated with the architecture. Bode equalizers, as described in U.S. Pat. No. 2,096,027, are a common type of adaptive equalizer that are suited to applications in which the channels can be simply parameterized. In particular, conventional Bode equalizers typically address channels where the signal distortion versus frequency can be represented with a known prototype function scaled by a single parameter corresponding to channel length. However, conventional Bode equalizers often provide insufficient performance in applications with channels that do not meet these criteria.

Various conventional techniques for equalizing signals exist in the art. One technique involves controlling an adaptive equalizer based on a comparison between the signal energy in a first frequency band and the signal energy in a second frequency band. The two frequency bands are chosen so that the respective signal energies in each band are nominally equivalent for an ideal signal spectrum. The adaptive equalizer applies an amount of compensation to the received signal according to a control variable. A control circuit adjusts the control variable of the adaptive equalizer based on the difference in signal energies between the two bands. When the measured signal energies are equivalent, the equalizer is adequately compensating for the channel distortions on the received signal, and the control variable settles on a stable value. The adaptive control circuit continues to monitor the two frequency bands of the equalized signal so that the equalizing filter can be adapted for any subsequent channel variations that may change the amount of distortion applied to the transmitted signal.

A conventional circuit 100 based on this conventional adaptive control technique is illustrated in FIG. 1. The equalized signal 102 is tapped off before it is input to the comparator 103 and split into two parallel control signals 161 and 162, which are coupled to a control circuit 110. The first control signal 161 is input to a first band-pass filter 163, whose pass band correlates to the first frequency band of interest. The output of the first band-pass filter 163 is fed to a first power detector 164, which provides a measure of the signal energy contained within the pass band of the first band-pass filter 163. The second control signal 162 is input to a second band-pass filter 165, whose pass band correlates to a second frequency band of interest that is higher in frequency than the first. The output of the second band-pass filter 165 is fed to a second power detector 166, which provides a measure of the signal energy contained within the pass band of the second band-pass filter 165. For a 270 Mb/s non-return-to-zero (NRZ) data stream, a typical first band-pass filter 163 would have a pass band from 10 MHz to 30 MHz, and a typical second band-pass filter 165 would have a pass band from 50 MHz to 70 MHz.

In practice, the power detectors 164, 166 may be realized as simple squaring blocks, with a low-pass integrating filter (not shown in this figure) included in each power detector 164, 166 so that the outputs of the power detectors 164, 166 are slowly varying compared to the data rate of the quantized signal 104. Typically, the bandwidth of these integrating filters will be several orders of magnitude less than the data rate. The outputs of the power detectors 164, 166 correspond to an analog estimate of the statistical variances (i.e. the square of the standard deviation) of the respective control signals 161, 162. Alternatively, full-wave rectifiers or half-wave rectifiers (not shown) may be used in place of a squaring block within the power detectors 164, 166. With the rectifier implementation, the outputs of the power detectors 164, 166 no longer correspond to error variances. Instead, the power detector outputs represent the approximate 1-norm of the respective control signals 161, 162, which still correlates to signal energy in the desired frequency range. Those skilled in the art appreciate that determining the “1-norm” of the respective control signals 161, 162 typically comprises integrating the absolute values of the control signals 161, 162.

The outputs of the two power detectors 164, 166 are input to a summation node 167 where the second integrated control signal is subtracted from the first integrated control signal to generate an error signal 168. A control block 169, which may be as simple as a scaling amplifier and an added offset, converts the error signal 168 into the control variable 106. The error signal 168 correlates to the amount of compensation applied by the equalizing filter 101. If the error signal 168 is positive, the equalizing filter 101 is under-compensating for the channel distortion, and the control block 169 increases the level of equalization by increasing the control variable 106. If the error signal 168 is negative, the equalizing filter 101 is over-compensating, and control block 169 decreases the level of equalization by decreasing the control variable 106. If the error signal 168 goes to zero, the equalizing filter 101 reaches it optimal state, and the level of equalization remains fixed as long as the error signal 168 remains zero.

In an alternative scenario, the signal energies in the frequency bands specified by the band-pass filters 163, 165 need not be equal, but merely fixed in relation to each other for an ideal, non-distorted signal. In such a case, the frequency-dependent distortions imposed on the signal by the channel causes the difference in the signal energies to differ from the known, fixed amount of the ideal case. The control circuit can be made to account for this fixed difference by adding fixed gain blocks (not shown in FIG. 1) to the outputs of the power detectors 164, 166 so that the outputs are scaled to account for the known offset of the ideal signal. Hence, when the signal energies as measured by the power detectors 164, 166 differ by the known, fixed amount, the gain block will offset the difference and the error signal 168 will still go to zero. That is, when the equalized signal exhibits signal energies in the first and second frequency bands that differ by the fixed amount of the ideal case, the control circuit 110 will fix the level of equalization.

The adaptive control system of Circuit 100, as illustrated in FIG. 1, provides a degree of immunity to variations in the amplitude of the transmitted signal 105 since any changes in transmit amplitudes manifest themselves in both the first and second control signals 161 and 162. However, this circuit 100 has a significant disadvantage in that its performance is based on the assumption that the signal energies in the frequency bands specified by the band-pass filters 163, 165 should be fixed in relation to each other when the equalizer reaches its optimal state.

This assumption is based on a condition of having an ideal signal spectrum, which is theoretical and not indicative of typical real-world circumstances. This assumption further constrains the applicability of the control method to a specific and narrow range of data rate and a specific signal spectrum. Changes in data rate or the type of signaling used at the transmitter can cause the equalizer control variable to settle at a non-optimal value since the transmitted signal may violate the underlying assumption that the signal energy in the two pass bands is equal, or at least different by a known and fixed amount.

For example, the exemplary pass bands given above would typically be ill-suited for data rates other than 270 Mb/s or for certain types of encoding, such as 8-bit/10-bit (8 b/10 b), which can dramatically change the transmitted signal spectrum. In other words, the equalizing filter 101 is adjusted based on prior knowledge of a specific ideal signal spectrum and an observation as to how much the equalized signal spectrum differs from the ideal. Consequently, one limitation of the conventional art, as illustrated in FIG. 1, is that the circuit's utility is somewhat limited to an undesirably narrow range of data rates and signal spectra.

Another conventional approach to providing equalization to a communication signal is based on controlling equalization on the basis of monitoring the edge energy of an equalized signal, as illustrated in Circuit 200 of FIG. 2. The equalized signal 102 is tapped off before it is input to the comparator 103 and fed to a first high-pass filter 251. The cutoff frequency of the high-pass filter 251 is typically chosen to be at least half of the lowest data rate that the equalizer circuit 200 should accommodate. The output of the first high-pass filter 251 is input to a first power detector 252, which provides a measure of the edge energy of the equalized signal 102. The quantized signal 104, which will have fast rise and fall times due to the limiting amplifier contained with the comparator 103, is tapped off and fed to a second high-pass filter 253. The output of the second high-pass filter 253 is input to a second power detector 254, which provides a measure of the edge energy of the quantized signal 104. The second high-pass filter 253 and the second power detector 254 are typically similar to the first high-pass filter 251 and the first power detector 252, respectively. The power detectors 252, 254 in Circuit 200 may include an integrator and are typically similar to those used in Circuit 100, which is illustrated in FIG. 1 and discussed above.

The outputs of the two power detectors 252, 254 in Circuit 200 are input to a summation node 255 where the output of the first power detector 252 is subtracted from the output of the second power detector 254 to generate an error signal 256. A control block 257, which may be a simple scaling amplifier and an added offset, converts the error signal 256 into the control variable 106. The error signal 256 correlates to the amount of compensation applied by the equalizing filter 101. If the error signal 256 is positive, the quantized signal 104 has more edge energy than the equalized signal 102, indicating that the equalizing filter 101 is under-compensating for the channel distortion. Subsequently, the control variable 106, and thus the level of equalization, will increase. If the error signal 256 is negative, the quantized signal 104 has less edge energy than the equalized signal 102, indicating that the equalizing filter 101 is over-compensating. Subsequently, the control variable 106, and thus the level of equalization, will decrease. If the error signal 256 goes to zero, the edge energies of the equalized and quantized signals 102, 104 are equivalent, indicating that the equalizing filter 101 has reached a state of optimal compensation. Subsequently, the level of equalization will remain fixed as long as the error signal 256 remains zero.

One advantage of the conventional adaptive control circuit 200 illustrated in FIG. 2 over the conventional circuit 100 illustrated in FIG. 1 and some other conventional circuits is that it is applicable to a somewhat broader range of data rates and signal spectra. This circuit 200 is applicable to a broader range of signal spectra and data rates because the equalized signal 102 is compared to the quantized signal 104, which will have a similar spectrum to the equalized signal 102 once the equalizer control variable has been optimized. In effect, the quantized signal 104 provides an improved exemplary signal to the control loop 210 to which the equalized signal 102 can be compared for the purpose of adapting the equalizing filter 101 with reduced dependence on data rate, signal encoding, or modulation technique.

However, the architecture of Circuit 200 is based on the assumption that the equalized and quantized signals 102, 104 have similar peak-to-peak amplitudes. Since this assumption can be imperfect in some applications, this circuit 200 may exhibit a disadvantageous sensitivity to changes in the transmit amplitude. Changes in transmit amplitude can change the transmitted signal spectrum by either increasing or decreasing signal energy. This change in the magnitude of the power spectral density (PSD) is manifested in the equalized signal 102 as well, but not in the quantized signal 104 since its amplitude is fixed by the limiting amplifier in the comparator 103. This discrepancy is not fully accounted for by the control loop 210 of the circuit 200 and can skew the adaptation of the control variable 106 to a suboptimal value.

A conventional approach to partially alleviating this problem is to add an automatic gain control (AGC) amplifier (not shown) to the circuit 200 immediately following the equalizing filter 101 but before the control signals are tapped off. This is not an ideal solution for a number of reasons. First, since the AGC setting is determined by a control variable based on an error signal, the equalizer control variable may not adapt properly since the two parameters (the equalizer control variable and the AGC control variable) simultaneously adjust based on a single observable (the error signal). In some instances, a fixed equalizer may be used with the control variable adjusting the AGC instead, but this usually provides only an overall gain control to the equalized signal and may not sufficiently compensate for the channel loss and dispersion over all relevant frequencies. While having an AGC in the data path of the receiver helps account for variations in transmit amplitude, it impedes the ability of the control loop to accurately adjust the equalizer control variable, since a control variable will be required to additionally control the AGC. In other words, connecting an AGC and an equalizer in a series arrangement can cause operational interference between these devices. Furthermore, in this architecture, AGCs can be undesirable for high-speed receivers since the bandwidth limitation of the AGC itself has a propensity to degrade the equalized signal.

To address these representative deficiencies in the conventional receiver art, what is needed is a capability for equalizing signals that accommodates a wide variance in operating conditions that are not necessarily known a priori. Furthermore, an equalizing circuit is needed that equalizes signals that have suffered various types and levels of signal degradation from transmission through lossy and/or dispersive transmission media. Such a capability would facilitate providing cost effective communications in diverse applications.

### SUMMARY OF THE INVENTION

The present invention supports processing communication signals to correct for signal distortion, such as signal distortion caused by transmission over a cable, backplane, or other medium. The present invention further supports correcting for such signal distortion over a broad range of communication data rates and operating conditions.

In one aspect of the present invention, a receiver circuit can correct signal distortion in a communication signal with an adjustable filter or an adjustable system of filters. The receiver circuit can include a component, such as a comparator, coupled to the adjustable filter. The comparator can compare the filtered communication signal to a reference signal and can amplify the result of the comparison. The receiver circuit can also include a control circuit that can adjust the adjustable filter based on a measurement of a characteristic of the communication signal leading into the comparator and another measurement of the characteristic of the communication signal leading out of the comparator. The control circuit's adjustments to the adjustable filter can equalize the communication signal, in effect minimizing the difference between the characteristic of the communication signal leading into the comparator and the characteristic of the communication signal leading out of the comparator while taking into account variations in the amplitude of the communication signal.

Taking into account variations in the amplitude of the communication signal can include monitoring slow variations, such as variations occurring on a per-second time scale, in the signal strength leading into and out of the comparator. In other words, the control circuit can adjust the adjustable filter. In response to the control input, the adjustable filter can cause a measured characteristic of the communication signal to be essentially equivalent on both the input and the output side of the comparator. Additionally, the control circuit can compensate for amplitude-related variations in the raw measurement of the characteristic by scaling the characteristic on each side of the comparator according to the amplitude on the opposite side.

In another aspect of the present invention, the communication signal can include high-frequency signal components and low-frequency signal components. High frequency components of a communication signal can be signal components that have a frequency higher than half the data rate of the signal. Low frequency components of a communication signal can be signal components that have a frequency lower than half the data rate of the signal. The characteristic of the communication signal that is equalized on both sides of the comparator can be an intensity or energy level in the high-frequency signal components. Taking into account variation in the amplitude of the communication signal can include monitoring the intensity or energy level in the low frequency components.

The discussion of processing communications signals presented in this summary is for illustrative purposes only. Various aspects of the present invention may be more clearly understood and appreciated from a review of the following detailed description of the disclosed embodiments and by reference to the drawings and claims.

### BRIEF DESCRIPTION OF THE DRAWINGS

FIG. 1 illustrates a functional block diagram of a conventional adaptive equalizer control loop.

FIG. 2 illustrates a functional block diagram of a conventional adaptive equalizer control loop.

FIG. 3 illustrates a functional block diagram of a communication system according to an exemplary embodiment of the present invention.

FIG. 4 illustrates a functional block diagram of a receiver circuit according to an exemplary embodiment of the present invention.

FIG. 5 is a graph illustrating the magnitude of the frequency response for an exemplary channel comprising 300 meters of coaxial cable according to an exemplary embodiment of the present invention.

FIG. 6A is a graph illustrating an exemplary pulse sequence before transmission across a lossy, dispersive channel according to an exemplary embodiment of the present invention.

FIG. 6B is a graph illustrating an exemplary pulse sequence after transmission across a lossy, dispersive channel according to an exemplary embodiment of the present invention.

FIG. 7 is a graph illustrating a power spectral density of an exemplary pulse sequence before and after transmission across a lossy, dispersive channel according to an exemplary embodiment of the present invention.

FIG. 8 is a graph illustrating a power spectral density of an exemplary pulse sequence with varying edge energies according to an exemplary embodiment of the present invention.

FIG. 9 illustrates a functional block diagram of an adaptive Bode equalizer according to an exemplary embodiment of the present invention.

FIG. 10 illustrates a functional block diagram of an adaptive equalizer control loop according to an exemplary embodiment of the present invention.

FIG. 11 illustrates a functional block diagram of an adaptive equalizer control loop according to an exemplary embodiment of the present invention.

FIG. 12 illustrates a process for adaptive equalization according to an exemplary embodiment of the present invention.

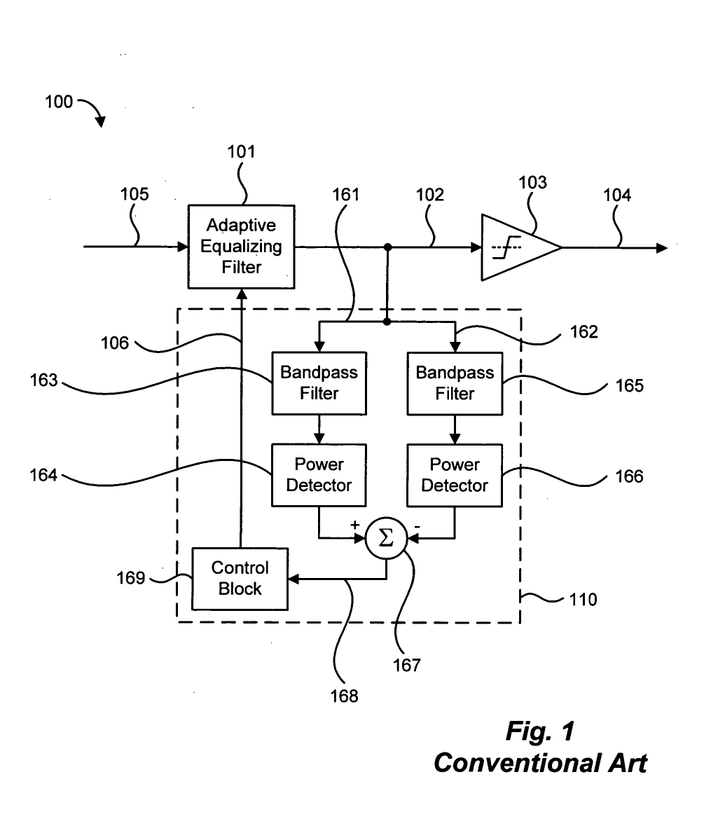

### DETAILED DESCRIPTION OF EXEMPLARY EMBODIMENTS

The present invention supports controlling an adaptive equalizer, such as a Bode equalizer or another type of equalizing filter, to provide compensation for frequency-dependent loss and ISI induced by a transmission medium while accounting for variations in the transmit amplitude and signal spectrum of a communication signal. Hence, the present invention can accurately adjust an equalizer to provide optimal or adequate compensation to the communication signal while accommodating significant variations in transmit amplitude, data rate, scrambling techniques, modulation methods, and other system variations.

The transfer function of an exemplary channel, having m zeros and n poles, may be represented by the following equation:

$$H ( s ) = \frac{( s + {z}_{1} ) ( s + {z}_{2} ) … ( s + {z}_{m} )}{( s + {p}_{1} ) ( s + {p}_{2} ) … ( s + {p}_{n} )} .$$

Ideally, an equalizing filter will have a transfer function that is exactly the inverse of the channel transfer function. That is, the zeros of the filter transfer function will exactly cancel the poles of the channel transfer function, and the poles of the filter transfer function will exactly cancel the zeros of the channel transfer function. Since the frequency response of a channel may vary due to numerous factors, such as length or temperature, many applications require that an equalizing filter be capable of correcting distortions for a range of channel variations.

An adaptive or adjustable equalizing filter can, in response to a signal or signals from a control circuit, provide an adjustable level, or degree, of signal conditioning, filtering, or equalization. That is, the control signal or signals adjust the locations of the zeros (and in some cases, the poles as well) of the filter transfer function to best approximate the inverse transfer function of a specific channel. Furthermore, the amount of equalization applied by the filter to a communication signal can vary with frequency. For example, an adaptive or adjustable equalizing filter might receive a signal with frequency components spanning from 100 to 600 megahertz (MHz). This filter might apply a gain of 100 to the signal components between 400 MHz and 600 MHz while applying a gain of 10 to the signal components between 100 MHz and 400 MHz.

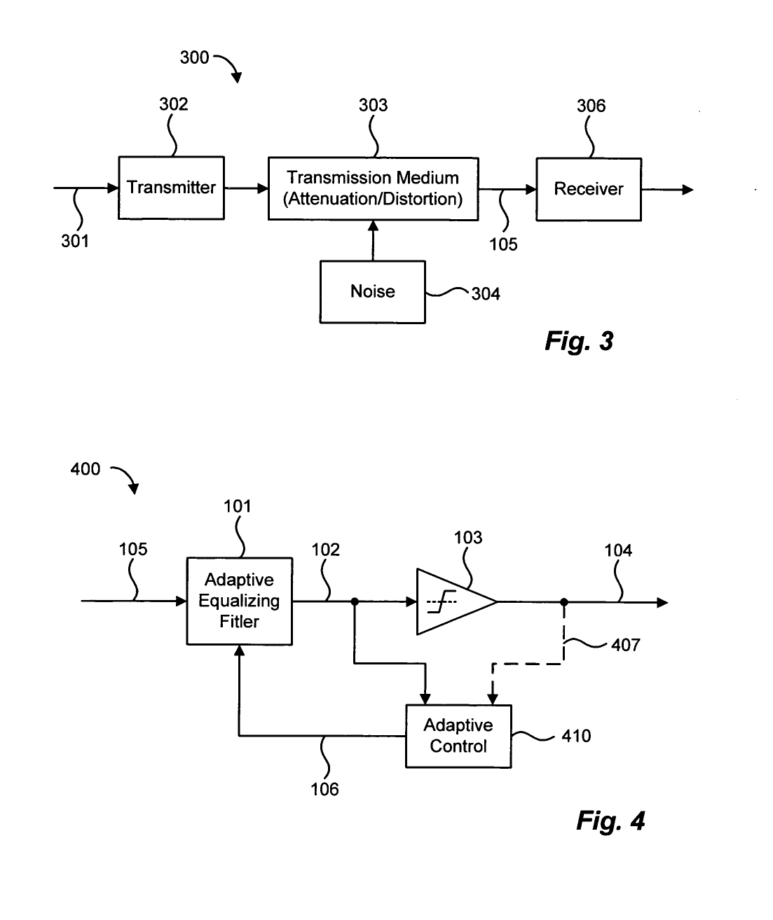

FIG. 3 illustrates a functional block diagram of a communication system 300 according to an exemplary embodiment of the present invention. An input communication signal 301 feeds a transmitter 302, which sends it through a transmission medium 303, such as a cable or backplane, to a receiver 306. As the signal 301 propagates through the transmission medium 303, it is contaminated by noise 304 so that the signal 105 delivered to the receiver 306 is distorted, attenuated, and/or otherwise impaired with respect to the original input signal 301. The receiver 306 converts the impaired signal 105 to a form, such as a digital, quantized signal, from which encoded information can be readily accessed.

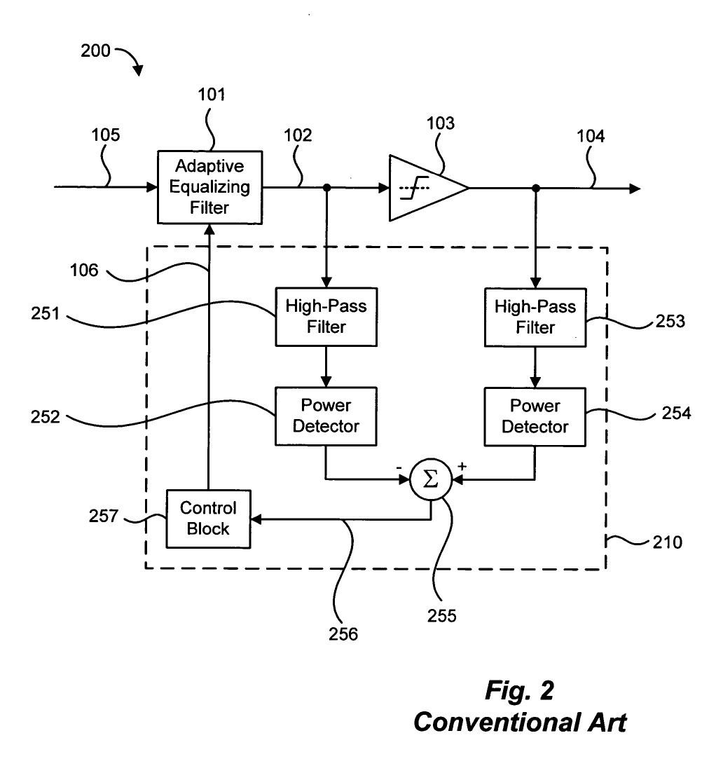

FIG. 4 illustrates an exemplary adaptive equalizer circuit 400 that can be included in the receiver 306 to restore signal fidelity to the received signal 105 according to an exemplary embodiment of the present invention. The received signal 105 is input to an adaptive equalizing filter 101. The output 102 of the equalizing filter 101, which will be referred to as the equalized signal 102, is then input to a direct current (DC) restoring comparator 103. The comparator 103, which includes a limiting amplifier, restores the DC component of the original signal 301 to the quantized signal 104 via quantized feedback or a similar technique. The quantized signal 104 then closely replicates the original signal 301 since the limiting amplifier digitizes the equalized signal 102, reshaping the pulse train with fast rise and fall times. An adaptive control circuit 410 uses the output of the equalizing filter to generate a control variable 106 (designated as alpha “d” in the discussion below) that, when fed-back to the equalizing filter 101, adjusts the amount of compensation applied to the received signal 105. The quantized signal 104 can also be used by the adaptive control mechanism to generate the control variable (illustrated in FIG. 2 with the dashed data path 407).

Cable loss, L_{c}, though the transmission medium 303 can often be approximated in the frequency domain as

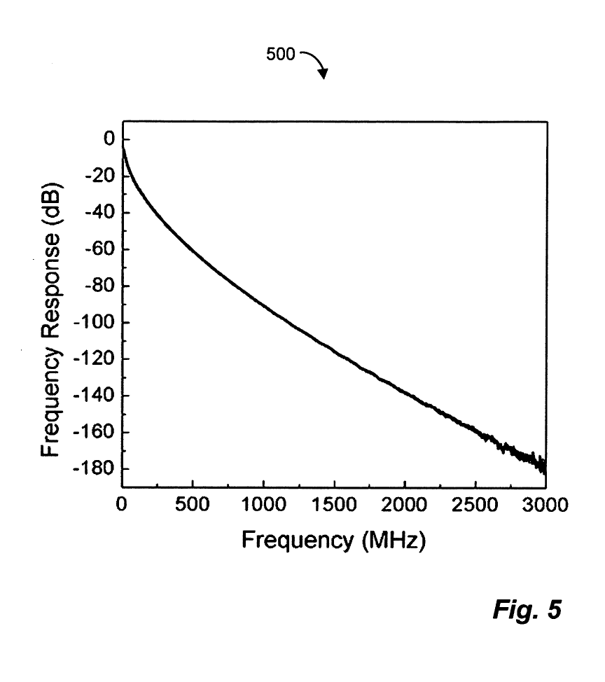

L_{c}(ƒ,l)=e⁻Al(l+j)\sqrt{ƒ}−jBlƒ−Clƒ,

where ƒ is frequency, l is the length of the cable, and A, B, and C are derived from the skin depth and dielectric constant of the cable. The magnitude of the frequency response for an exemplary coaxial cable that is 300 meters long is illustrated in the plot 500 of FIG. 5. Cable losses increase in correspondence to increased frequency of a signal propagating in the cable. For example, propagation over the 300-meter cable attenuates a 1200-MHz signal by approximately 100 dB so that about one percent of the signal launched into one end of the cable is emitted from the opposite end. A typical communication signal has numerous frequency components rather than one pure frequency. Propagation over the cable causes a different level of attenuation for each of these signal components. Consequently, the aggregate communication signal exhibits distortion that is not readily correctable with a single application of gain. The present invention can apply a frequency-dependent level of gain to a communication signal to overcome frequency-dependent loss.

Neglecting reflection effects (an acceptable assumption for many backplanes) the loss of a backplane trace can be approximated using similar functional dependencies as cable loss, although an extra term with an f² dependence can be included in the exponent. As the frequency dependence of the channel characteristics becomes increasingly complex, more sophisticated adaptive equalizer architectures can be used to adequately restore signal fidelity. A backplane trace subjected to significant sources of reflection in the data path and/or crosstalk interference from neighboring channels is an example of such a complex channel.

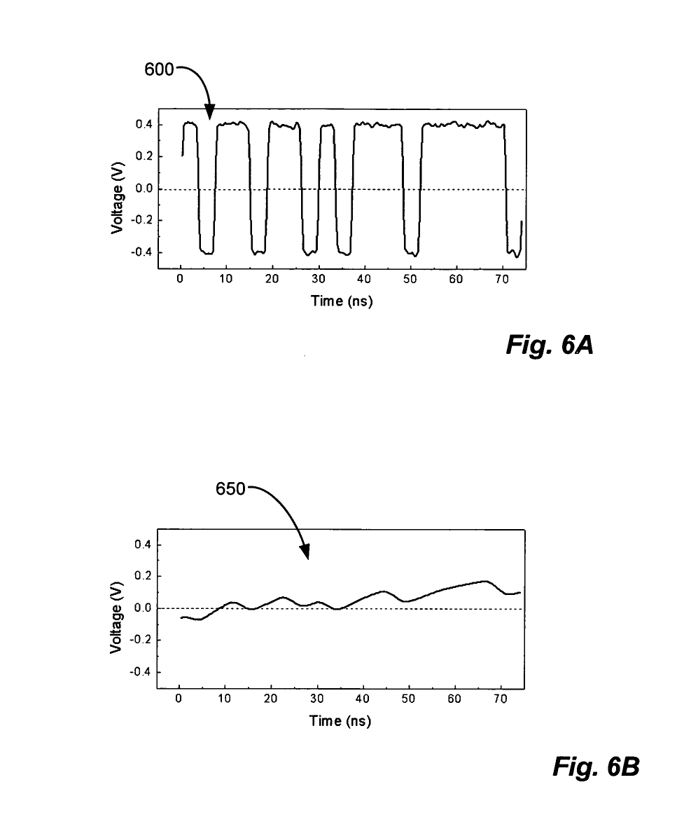

To better understand the signal distortions requiring compensation by an equalizer, FIGS. 6A and 6B show an exemplary pulse sequence 600 of a near-ideal 270 Mb/s NRZ signal before and after transmission across the exemplary, 300-meter cable plotted in FIG. 5. The launched signal 600 in FIG. 6A has a peak-to-peak voltage of 800 millivolts (mV) and a 10%-90% rise time of 0.64 nanoseconds (ns). The received pulse sequence 650 in FIG. 6B clearly illustrates the attenuation and dispersion imposed on a signal by a channel. Frequency-dependent losses impart greater attenuation on the higher frequency signal components than on the low frequency components. The high-frequency components are associated with the edges, or vertical transitions, of the launch signal 600, as depicted in FIG. 6A. In contrast, the received signal 650 in FIG. 6B is dominated by low frequency signal components that appear as an oscillation without steep edges. That is, transmission over the exemplary cable attenuates high-frequency signal components of a communication signal 600, removes sharp edges in a pulse sequence 600, and creates a distorted signal 650. The present invention can correct such a distorted signal 650 so that it is properly conditioned for extracting information coded thereon.

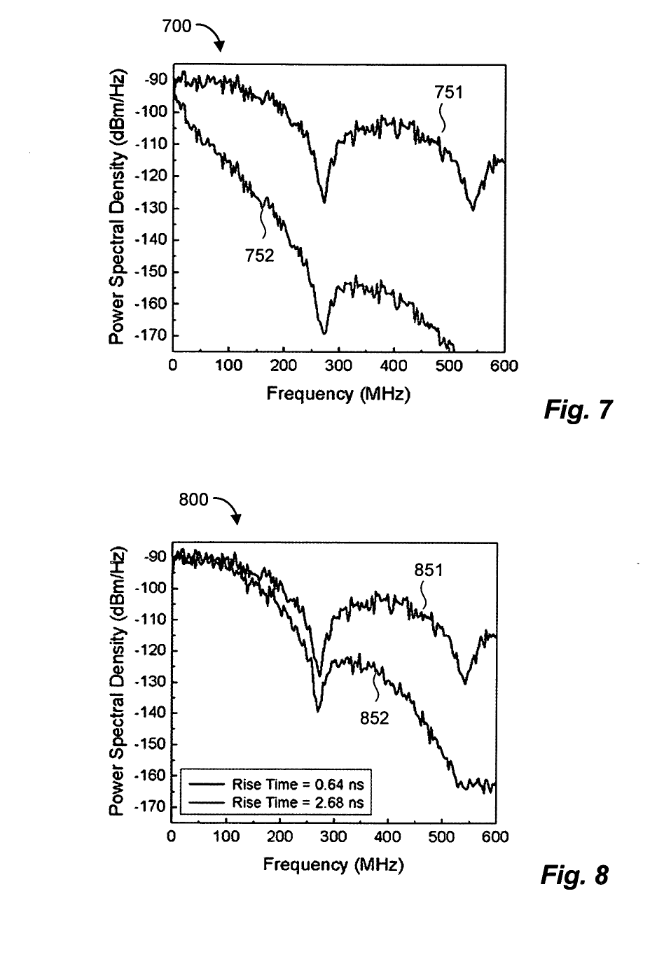

PSD plots for the launched signal 751 and the received signal 752 are shown in FIG. 7. The graph 700 of FIG. 7 illustrates the power of the communication signals 600, 650 distributed in frequency and thus facilitates observing the general shape of a signal's spectrum. Below 100 MHz, the PSD difference between the launched signal spectrum 751 and the received signal spectrum 752 is less than approximately 30 dBm/Hz (decibels as referenced to one milliwatt per Hertz). Above 400 MHz, this difference is greater than approximately 55 dBm/Hz. In other words, the low-frequency components of the communication signals 600, 650, which are on the left side of the graph 700 exhibit less loss as a result of transmission over the exemplary cable than do the high-frequency components on the right side of the graph 700.

The adaptive equalizer of the present invention can monitor the spectrum of the equalized signal 102 (or a related parameter such as edge energy) and adjust the level of compensation provided by the equalizer 101 based on how much that spectrum (or the related parameter) differs from the near-ideal case 751. That is, the present invention can include circuitry that amplifies high-frequency components of a communication signal more than low-frequency components of a signal. Such frequency-selective amplification can boost the received signal 650 so that it exhibits a PSD plot that is similar to the PSD plot 751 of the launched signal 600.

The relationship between edge energy and signal spectrum is illustrated in FIG. 8, which provides a plot of the PSD for a 270 Mb/s NRZ signal 851 with a 0.64 ns rise time and a plot of a similar signal 852 with a 2.68 ns rise time. Below 100 MHz, the spectra of both signals 851, 852 are nearly identical, yet because the signals have different edge energies due to the discrepancy in rise times, the high-frequency portion of the spectra 851, 852 are significantly different. Hence, comparing the edge energies of two different signals with the same data rate gives an approximate measure of the differences between the two signal spectra.

Rise time is typically associated with signal quality so that fast rise time usually indicates better signal performance than slow rise time. Consequently signal 851, which has a rise time of 0.64 ns, is a more desirable signal than signal 852, which has a rise time of 2.68 ns. Below approximately 250 MHz, the two signals 851, 852 exhibit comparable levels of energy. Above 250 MHz, the 0.64-ns-rise-time signal 851 has higher energy than the 2.68-ns-rise-time signal 852. Such signal quality is, therefore, visible in the spectrum 851 by the greater signal energy carried in the upper frequency range. By restoring the high-frequency energy content of a received communication signal to a robust level, the present invention can correct degraded rise time so that information can be readily extracted from the signal.

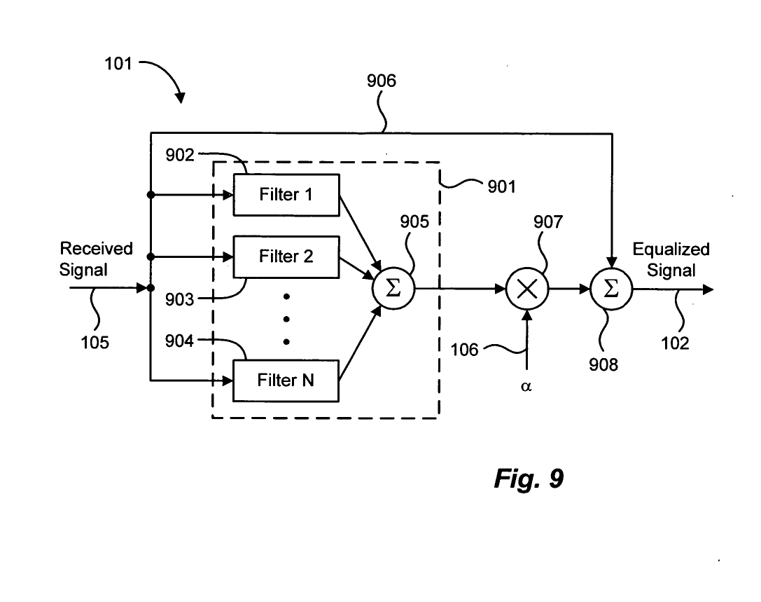

Turning now to FIG. 9, the present invention can provide an improved. technique for adaptation of a Bode equalizer. An exemplary adaptive Bode equalizing filter 101 is illustrated in FIG. 9 according to an embodiment of the present invention. The received signal 105 is input to a filter network 901. The filter network 901 includes N filters 902, 903, 904. The transfer functions of the individual filters 902, 903, 904 can be represented as Hᵢ(ƒ), where i=1 to N. The outputs of the N filters 902, 903, 904 are combined at a first summation node 905. The output of the first summation node 905 is multiplied by the control variable 106, which varies with channel length. The control variable alpha, α, ranges in value from 0 to 1 depending on the amount of compensation needed to restore the signal fidelity of the received signal. The output of an all-pass data path 906, in parallel with the filter network 901, is then summed with the output of the multiplier 907 at a second summation node 908. The output of the second summation node 908 provides the equalized signal 102. The total transfer function of the adaptive equalizing filter 101 shown in FIG. 4 is given as:

$${H}_{TOTAL} ( α , f ) = 1 + α {\sum }_{i = 1}^{N} {H}_{i} ( f ) .$$

One skilled in the art will readily appreciate that the present invention supports variations of the exemplary the filter network 901 illustrated in FIG. 9. More specifically the filter network 901 can be readily adapted according to the needs of various applications. Ideally, for a specified maximum channel length, L, H_{TOTAL}(ƒ) should equal the inverse of the channel loss when α =1. In many applications, an exact match is not feasible and the filter transfer function is designed to approximate the inverse of the channel as closely as possible while ensuring that the composite group delay of the channel and filter remains relatively constant as a function of frequency to reduce jitter in the equalized signal. Hence, the actual architecture of an adaptive Bode equalizer may change significantly from the exemplary architecture shown in FIG. 9 in order to better approximate the inverse of a particular channel response. While the example 101 shown in this figure uses a network of parallel filters, serial filters or a combination of serial and parallel filters may be preferable for certain channels. Likewise, the circuit shown in FIG. 9 can constitute only one stage of a multi-stage equalizing filter, where each stage is controlled by a separate control variable. In any case, the individual filter transfer functions, Hᵢ(ƒ), can be optimized for a given channel so that:

H_{TOTAL}(α=1,ƒ)≈[H_{CHANNEL}(1=L,ƒ)]⁻¹.

Finally, the level of adaptation of the embodiment shown in FIG. 9 amounts to scaling the output of the filter network 901 by alpha, α, reducing the amount of applied compensation for channel lengths less than L. More complex Bode architectures may use one or more control variables to shift the locations of the poles and zeros in the individual filter transfer functions to better compensate for channel loss at intermediate lengths.

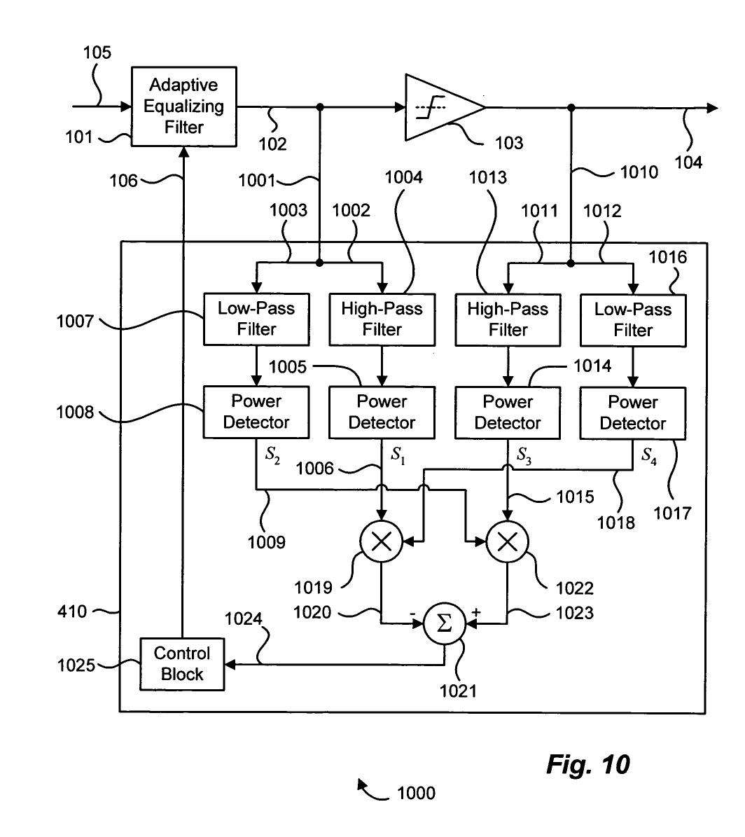

Turning now to FIG. 10, this figure illustrates an equalizing circuit 1000 according to an exemplary embodiment of the present invention. Under feedback control, an adaptive equalizer 101 restores signal fidelity to the received signal 105 by compensating for channel loss and dispersion and also alleviates receiver sensitivity to transmit amplitude and signal spectrum.

Circuit 1000 uses the difference in edge energies of the equalized signal 102 and the quantized signal 104 to determine an error signal 1024, which, in turn, adjusts the control variable 106. The circuit 1000 uses a combination of filtering and power detection to measure edge energies. For the equalized signal 102 and the quantized signal 104, high-pass filter 1004 and high-pass filter 1013, respectively, isolate the appropriate frequency components corresponding to edge energy, and the signal energy in the frequency range determined by these filters 1004, 1013 is measured with power detectors 1005, 1014.

Before generating the error signal 1024, the edge energy measurement 1006 of the equalized signal 102 is scaled by a measure of the low-frequency energy 1018 in the quantized signal 104. Likewise, the edge energy measurement 1015 of the quantized signal 104 is scaled by a measure of the low-frequency energy 1009 in the equalized signal 102. The low-frequency energy measurements 1009, 1018 for the equalized and quantized signals 102, 104 are obtained by low-pass filtering the respective signals 102, 104 with low-pass filters 1007, 1016 and feeding the filtered outputs into power detectors 1008, 1017.

If the power detectors 1005, 1008, 1014, 1017 used for both the low-frequency and edge energy measurements incorporate integrators, the scaling functions are typically performed at speeds that are orders of magnitude less than the data rate. The error signal 1024 is generated by subtracting the edge energy 1006 of the equalized signal 102, scaled by the low-frequency energy 1018 of the quantized signal 104, from the edge energy 1015 of the quantized signal 104, scaled by the low-frequency energy 1009 of the equalized signal 102.

The scaling function accounts for any discrepancy that may exist between the peak-to-peak amplitude of the equalized signal 102 and that of the quantized signal 104 since any such discrepancy will be manifested in the low-frequency signal energies 1009, 1018. Thus, the error signal 1024 correlates to the difference in edge energies of the equalized and quantized signals 102, 104 and is not skewed by any low-frequency discrepancies that may exist between the two signal spectra. As such, the circuit 1000 is insensitive to changes in transmit amplitude, which correlate to changes in the equalized signal amplitude.

A first control signal 1001 is tapped off from the equalized signal 102 and subsequently split into a first parallel control signal 1002 and a second parallel control signal 1003. The first parallel control signal 1002 is input to a first high-pass filter 1004, the output of which is, in turn, input to a first power detector 1005. The cutoff frequency of the first high-pass filter 1004 is typically greater than or equal to half the data rate. If the adaptive equalizer 1000 is intended to operate over a range of data rates, the cutoff frequency of high-pass filter 1004 is typically greater than or equal to half the minimum data rate.

Power detector 1005, which can include an integrator (not shown in the FIG. 10), outputs a signal 1006 that has an amplitude that is proportional to the edge energy of the equalized signal 102. The bandwidth of the integrator is typically chosen to be several orders of magnitude less than the minimum data rate. The output 1006 of the first power detector 1005 is denoted as S₁. The second parallel control signal 1003 is input to a first low-pass filter 1007, the output of which is, in turn, input to a second power detector 1008. The cutoff frequency of the low-pass filter 1007 is typically equal to the cutoff frequency of high-pass filter 1004. Power detector 1008, which is similar to power detector 1005, outputs a signal 1009, whose amplitude is proportional to the low-frequency energy of the equalized signal 102. The output 1009 of power detector 1008 is denoted as S₂.

A second control signal 1010 is tapped off from the quantized signal 104 and subsequently split into a third parallel control signal 1011 and a fourth parallel control signal 1012. The third parallel control signal 1011 is input to high-pass filter 1013, the output of which is, in turn, input to power detector 1014. The cutoff frequency of the high-pass filter 1013 can approximate that of the high-pass filter 1004. Power detector 1014, which is typically similar to power detector 1005, outputs a signal 1015 whose amplitude is proportional to the edge energy of the quantized signal 104. The output 1015 of the power detector 1014 is denoted as S₃.

The fourth parallel control signal 1012 is input to a low-pass filter 1016, the output of which is, in turn, input to power detector 1017. The cutoff frequency of the low-pass filter 1016 can approximate that of the low-pass filter 1007. Power detector 1017, which is also typically similar to power detector 1005, outputs a signal 1018 whose amplitude is proportional to the low-frequency energy of the equalized signal 102. The output 1018 of power detector 1017 is denoted as S₄.

In practice, the power detectors 1008, 1005, 1014, 1017 can be realized as simple squaring blocks with each having an integral low-pass filter (not shown). Such integral filters cause the power detector outputs to vary slowly compared to the data rate of the quantized signal 104. Typically, the bandwidth of these integrating filters will be several orders of magnitude less than the data rate. The outputs of the power detectors 1008, 1005, 1014, 1017 typically correspond to an analog estimate of the statistical variances (i.e. the square of the standard deviation) of the respective control signals.

As an alternative to a squaring block, each power detector 1008, 1005, 1014, 1017 can include full-wave rectifiers or half-wave rectifiers (not shown). Using rectifiers, the outputs of the power detectors 1008, 1005, 1014, 1017 do not typically correspond to error variances. Instead, the power detector outputs based on rectifiers represent the approximate 1-norm of the respective control signals, which still correlates well to signal energy in the desired frequency range.

The signal S₁ 1006 and the signal S₄ 1018 are input to a first multiplier 1019, and the resulting product 1020 is fed to a first input of a summation node 1021. The signal S₂ 1009 and the signal S₃ 1015 are input to a second multiplier 1022, and the resulting product 1023 is fed to a second input of the same summation node 1021. The summation node 1021 subtracts the first input 1020 from the second input 1023 to generate the error signal 1024.

The error signal 1024 varies slowly compared to the data rate and is proportional to the difference in edge energies of the equalized signal 102 and the quantized signal 104, scaled by the low-frequency energies of these signals 102, 104. The error signal can be represented as:

Error Signal=S₂S₃−S₁S₄.

A control block 1025 converts the error signal 1024 into the control variable 106, which is fed back to the adaptive equalizer 101. A simple implementation of the control block 1025 can include a scaling amplifier and an added offset.

In certain applications, band-pass filters may be substituted for the high-pass filters 1013, 1004 and/or the low-pass filters 1007, 1016 that are illustrated in Figure 10. For example, the bandwidth limitations of an equalizing filter, in some cases, can prevent the equalized signal from ever attaining an edge energy equivalent to the quantized signal, and the high-pass filters 1013, 1004 should be replaced with band-pass filters to address this condition. In such a case, the pass bands can span a frequency range over which the spectra of the equalized and quantized signals 102, 104 are equivalent when the outputs of the filters are appropriately scaled by low-frequency energies and the equalizer has been adjusted to its optimal setting.

One skilled in the arts will recognize that an alternative embodiment of the circuit 1000 may include fixed gain blocks following the filters 1004, 1013. These gain blocks could be used to offset known discrepancies in the scaled signals 1020, 1023. For example, if the bandwidth limitations of the equalizing filter prevent the equalized signal from ever attaining edge energies comparable to the quantized signal and the bandwidth limitations of the filter are known, the gain blocks can re-scale either or both of the scaled signals 1020, 1023 to account for this discrepancy and enable the equalizing filter to properly equalize the received signal.

Circuit 1000 can function adequately without an AGC element in the data path by providing an automatic gain control function in the control loop via the low-frequency scaling function. That is, the low-frequency scaling function provides automatic gain control that is integral to the control loop 410 and does not require discreet, dedicated AGC circuit components. Since the scaling function occurs after the control signals are integrated, the de facto automatic gain control of Circuit 1000 further simplifies the control loop architecture since one or more separate high-speed AGC components in the data path are not required.

One skilled in the art will appreciate that the present invention supports applying automatic scaling of the control signals to generate an accurate error signal in numerous applications. For example, a measured parameter related to signal spectrum other than edge energy can be used to adapt the equalizing filter.

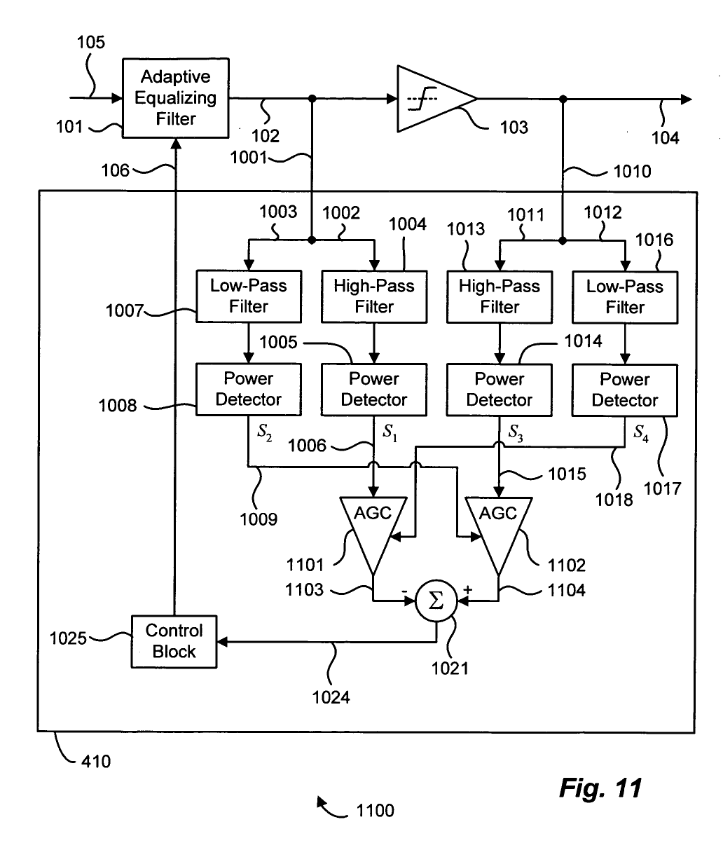

As an alternative to the multipliers illustrated in FIG. 10, the present invention can include AGC amplifiers outside of the data path. Turning now to FIG. 11, this figure illustrates a circuit 1100 with AGC amplifiers 1101, 1102 according to an exemplary embodiment of the present invention. Signal S₁ 1006 is input to the AGC 1101, while signal S₃ 1015 is input to the AGC 1102. Signal S₄ 1018 is used to control the gain of AGC 1101, while signal S₂ 1009 is used to control the gain of the AGC 1102. The output 1103 of the AGC 1101 is subtracted from the output 1104 of the second AGC 1102 at the summation node 1021. The output 1024 of the summation node 1021 is an error signal 1024 proportional to the difference in edge energies of the equalized signal 102 and the quantized signal 104, scaled by the low-frequency energies of these signals 102, 104.

Similar to the circuit 1000 illustrated in FIG. 10, the error signal 1024 of Circuit 1100 can be represented as:

Error Signal=S₂S₃−S₁S₄.

The control loop 410 of Circuit 1100 alleviates the need for automatic gain control in the data path by using automatic gain control at a much lower bandwidth to appropriately scale the control signals used to generate error signal.

In one embodiment of the present invention, band-pass filters are substituted for the high-pass filters 1004 and 1013. Such an embodiment may provide advantages for some applications in which the limitations of circuit technologies may make high-pass filters infeasible or when the application benefits from control variable adjustments based on a signal parameter other than edge energy. In one embodiment of the present invention, the pass bands of each band-pass filters can be equal to one another and chosen so as to isolate the portion of the signal spectra that best correlates to the desired signal parameter. In one embodiment of the present invention based on band-pass filters, the cutoff frequency of the low-pass filters 1007 and 1016 will remain at approximately half the minimum data rate.

In an alternative embodiment of the present invention, circuit 1100 uses the AGCs 1101, 1102 to scale the AGC outputs 1103, 1104 to account for a known discrepancy in the monitored signal parameters of the equalized and quantized signals 102, 104. For example, if the bandwidth limitations of the equalizing filter prevent the equalized signal from attaining edge energies comparable to the quantized signal and the bandwidth limitations of the filter are known, the AGCs can scale either or both of the scaled signals 1103, 1104 to account for this discrepancy and enable the equalizing filter to properly equalize the received signal.

Those skilled in the art will appreciate that, although the embodiments illustrated in FIGS. 10 and 11 are single-ended, the invention may be implemented in a differential architecture when necessitated by the design requirements of a receiver.

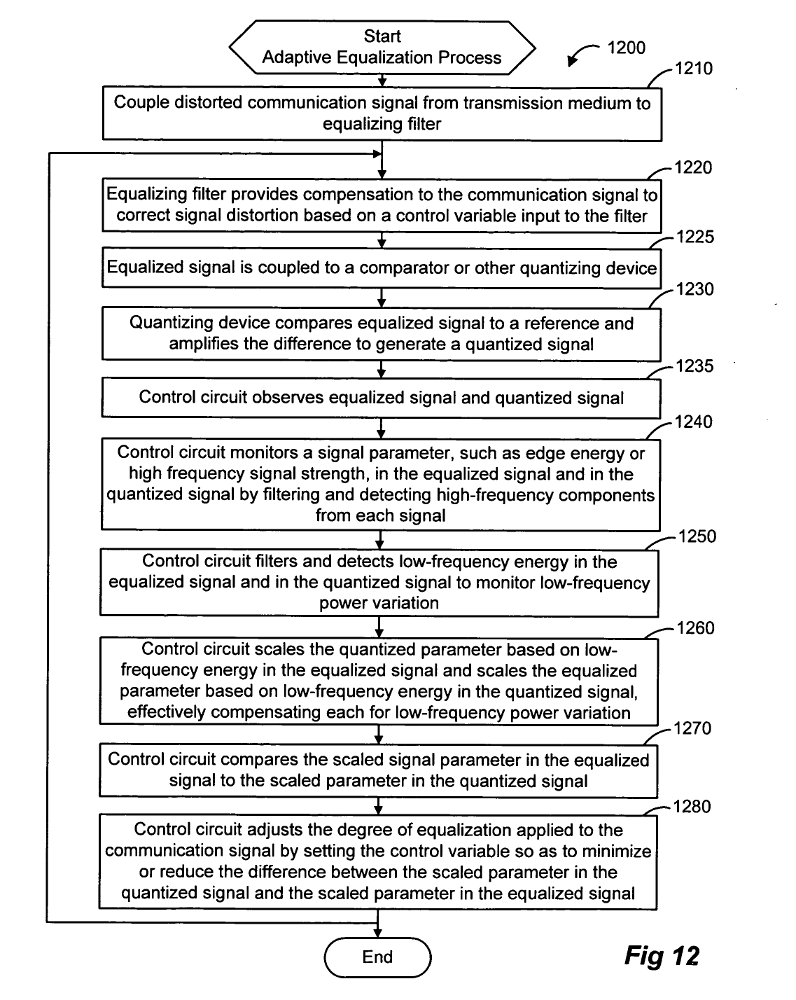

Turning now to FIG. 12, this Figure illustrates an exemplary process 1200, entitled Adaptive Equalization, that corrects distortion in a communication channel. Step 1210 is the first step in the process in which an adaptive equalizing filter 101, such as a Bode equalizer, accepts a distorted communication signal from a medium 303, as illustrated in FIG. 3. The medium 303 can be lossy and dispersive and can impart noise 304 or other signal impairments on the communication signal as well.

At Step 1220, the adaptive equalizing filter 101 compensates for distortion of a communication signal due to frequency-dependent loss and ISI induced by a communication channel, such as a lossy transmission cable. When the equalizing filter settings are optimized, the corrected signal exhibits a signal fidelity similar to the signal that was launched into the opposite end of the communication channel, before undergoing transmission distortion.

The adaptive equalizing filter 101 can be a Bode equalizer or other device that corrects signal distortion. The adaptive equalizing filter 101 is adjustable so that it can be adapted or controlled to provide equalization to a broad range of signals and data rates under a broad range of operating conditions. This filter 101 provides a level of equalization that is adjustable under control of a control loop 410. The filter 101 can also include one or more filtering parameters that can be adjusted to vary the level or degree of equalization that is applied to various frequency components of the communication signal.

At Step 1225, the equalized signal 102 that is output by the adaptive equalizing filter 101 is coupled to a comparator 103 or other quantizing device. A quantizing device is a device that provides two or more discrete outputs based on the intensity of an input signal. That is, a quantizing device outputs two or more signal levels based on comparing an input signal to another signal.

At Step 1230, the comparator 103, or other quantizing device, compares the equalized signal 102 to a reference and amplifies the difference. In one embodiment of the present invention, the comparator 103 provides two or more discrete signal levels based on the results of the comparison. The comparator 103 outputs a quantized signal based on its comparison. In the case of a digital transmission system, the quantized comparator output can consist of a two-level digitized signal.

At Step 1235, a control circuit 410 observes the equalized signal 102 and the quantized signal 104. That is, the control circuit 410 taps both the communication signal leading into the comparator 103 and the communication signal leading out of the comparator 103.

At Step 1240, the control circuit 410 monitors a signal parameter in each of the equalized signal 102 and the quantized signal 104. In one embodiment of the present invention, this monitored parameter is edge energy or high-frequency signal strength and the control circuit 410 can include filters 1004, 1013 to extract high-frequency signal components. Monitoring or detecting edge energy or high-frequency signal strength, as described herein, is not limited to quantifying edge energy or high-frequency signal strength on a scale with units such as decibels or milliwatts. Rather, monitoring or detecting edge energy or high-frequency signal strength can include establishing a voltage or current signal that is directly or indirectly correlated with edge energy or high-frequency signal strength. The present invention can use such a current or voltage signal without assigning a specific voltage or current measurement to the signal. That is, the present invention can control an adaptive equalizing filter 101 based on monitoring signal levels without measuring such signals on a scale.

At Step 1250, the control circuit 410 monitors the low-frequency power or energy in each of the equalized communication signal 102 and the quantized communication signal 104. In one embodiment of the present invention, the control circuit 410 conducts this monitoring by filtering the sampled equalized signal and the sampled quantized signal using low-pass filters 1007, 1016 and feeding the filter outputs to power detectors. The filtered equalized signal and the filtered quantized signals are coupled to respective detectors, such as power detectors 1008, 1017.

At Step 1260, the control circuit 410 scales the monitored parameter of the quantized communication signal 104 according to the low-frequency energy in the equalized signal 102. In a similar manner, the control circuit 410 scales this monitored parameter of the equalized communication signal 102 according to the low-frequency energy in the quantized signal 104. This scaling effectively compensates for low-frequency power variations in the transmitted communication signal.

At Step 1270, the control circuit 410 compares the scaled parameters to one another. That is, the control circuit 410 compares the monitored parameter in the equalized signal 102 to the monitored parameter in the quantized signal 104, taking into account, or compensating for, low-frequency power drift, variation, or fluctuation.

At Step 1280, the control circuit 410 adjusts the degree or level of equalization applied by the adaptive equalizing filter 101 based on the comparison. The control circuit 410 adjusts one or more parameters of the adaptive equalizing filter 101 in a manner that minimizes or otherwise reduces the difference between the two scaled parameters. For example, when the control circuit 410 sets the adaptive equalizer filter 101 to provide optimal equalization to the communication signal, the difference between the scaled parameter of the equalized signal 102 and the scaled parameter of the quantized signal 104 can reach a minimum value. Process 1200 iterates Step 1220 through Step 1280 to provide continual adaptation. This action helps the receiver to correct for a broad range of operating conditions, signal variations, and data rates.

Although the present invention can comprise a circuit that controls an adaptive Bode equalizer for a digital communication channel, those skilled in the art will appreciate that the present invention is not limited to this application and that the embodiments described herein are illustrative and not restrictive. Furthermore, it should be understood that various other alternatives to the embodiments of the invention described here may be employed in practicing the invention. The scope of the invention is intended to be limited only by the claims below.

What is claimed is:

1. A signal processing method comprising the steps of:
receiving a signal having a level of distortion;
filtering the signal according to a filter parameter to reduce the level of distortion;
comparing the filtered signal to a reference;
generating a quantized signal, having at least two signal levels, based on the comparison;
detecting a signal parameter of each of the filtered signal and the quantized signal;
detecting an energy in each of the filtered signal and the quantized signal;
adjusting the filter parameter based on the signal parameter of the filtered signal, the signal parameter of the quantized signal, and at least one of the detected energies; and
responsive to the adjusting step, further reducing the level of distortion.

2. The method of claim 1, wherein detecting the signal parameter comprises detecting a second energy in a frequency component of each of the filtered signal and the quantized signal.

3. The method of claim 1, wherein:
the signal has a data rate; and
detecting the signal parameter comprises detecting a second energy in a component of each of the filtered signal and the quantized signal, the component having a frequency higher than one half of the data rate.

4. The method of claim 1, wherein:
the signal has a data rate; and
detecting the energy comprises detecting the energy in a component in each of the filtered signal and the quantized signal, the component having a frequency less than the data rate.

5. The method of claim 1, further comprising the steps of:
scaling the signal parameter of the filtered signal based on the energy in the quantized signal; and
scaling the signal parameter of the quantized signal based on the energy in the filtered signal.

6. The method of claim 1, further comprising the steps of:
scaling the signal parameter of the filtered signal based on the energy in the quantized signal;
scaling the signal parameter of the quantized signal based on the energy in the filtered signal; and
comparing the scaled signal parameter of the filtered signal to the scaled signal parameter of the quantized signal, wherein the adjusting step comprises adjusting the filter parameter based on the comparison.

7. A method for processing a communication signal having a data rate comprising the steps of:
applying a degree of equalization to the communication signal;
quantizing the equalized communication signal;
monitoring a parameter in each of the equalized communication signal and the quantized communication signal;
monitoring a low-frequency energy in at least one of the equalized communication signal and the quantized communication signal, the low-frequency energy having a frequency less than the data rate;
comparing the monitored parameter in the equalized communication signal to the monitored parameter in the quantized communication signal and compensating the comparison according to the monitored low-frequency energy in the at least one of the equalized communication signal and the quantized communication signal; and
adjusting the degree of equalization responsive to the comparing step.

8. The method of claim 7, wherein:
monitoring the low-frequency energy comprises determining a difference between the monitored low-frequency energy in the equalized communication signal and the monitored low-frequency energy in the quantized communication signal; and
the comparing step comprises comparing the monitored parameter in the equalized communication signal to the monitored parameter in the quantized communication signal and compensating the comparison according to the difference in the low-frequency energy.

9. The method of claim 7, wherein:
monitoring the low-frequency energy comprises:
monitoring the low-frequency energy in the equalized communication signal; and
monitoring the low-frequency energy in the quantized communication signal; and
the comparing step comprises:
scaling the monitored parameter in the equalized communication signal based on the monitored low-frequency energy in the quantized communication signal;
scaling the monitored parameter in the quantized communication signal based on the monitored low-frequency energy in the equalized communication signal; and
comparing the scaled parameter of the equalized communication signal to the scaled parameter of the quantized communication signal.

10. The method of claim 7, further comprising the steps of:
transmitting the communication signal through a medium;
causing a distortion of the communication signal with the medium; and
receiving the distorted communication signal from the medium, wherein the applying step comprises applying the degree of equalization to the received communication signal to correct the distortion.

11. The method of claim 7, wherein the parameter comprises edge energy.

12. The method of claim 7, wherein monitoring the parameter comprises detecting a power in a frequency component in each of the equalized communication signal and the quantized communication signal.

13. The method of claim 7, wherein monitoring the parameter comprises detecting a power in a high-frequency component in each of the equalized communication signal and the quantized communication signal, wherein the frequency of the high-frequency component is greater than one half of the data rate.

14. The method of claim 7, wherein quantizing the equalized communication signal comprises processing the equalized communication signal with a comparator.

15. The method of claim 7, wherein applying the degree of equalization to the communication signal comprises filtering the communication signal.

16. The method of claim 7, wherein applying the degree of equalization to the communication signal comprises processing the communication signal with a Bode equalizer.

17. A signal processing circuit comprising:
a filter for filtering a communication signal;
a comparator coupled to an output of the filter for comparing the communication signal to a reference; and
a control circuit coupled to the filter and the output of the filter and an output of the comparator, the control circuit adjusting the filter based on a first frequency range of the communication signal sampled at the filter output and the comparator output and a second frequency range of the communication signal sampled at the filter output and the comparator output.

18. The circuit of claim 17, wherein the filter is operative to compensate for a distortion in the communication signal.

19. The circuit of claim 17, wherein the filter comprises an equalizing filter.

20. The circuit of claim 17, wherein the control circuit comprises:
a high-pass filter, passing electric signals with frequencies above a first frequency threshold and attenuating electric signals with frequencies below the first frequency threshold; and
a low-pass filter, passing electric signals with frequencies below a second frequency threshold and attenuating electric signals with frequencies above the second frequency threshold.

21. The circuit of claim 17, wherein the control circuit is further operative to adjust the filter in response to a difference between a first edge energy of the communication signal at the filter output and a second edge energy of the communication signal at the comparator output.

22. The circuit of claim 17, wherein the filter comprises a Bode equalizer.

23. The circuit of claim 17, wherein the control circuit is further operative to provide equalization to the communication signal by reducing a difference between an edge energy of the communication signal at the filter output and the edge energy of the communication signal at the comparator output.

24. The circuit of claim 17, wherein the comparator is further operative to quantize the communication signal.
